(19) United States
(12) Patent Application Publication
(10) Pub. No.: US 2020/0298957 A1
(43) Pub. Date: Sep. 24, 2020

(54) VORTEX WAKE ATTENUATION DEVICE

(71) Applicant: INSTITUT SUPERIEUR DE L'AERONAUTIQUE ET DE L'ESPACE - ISAE, TOULOUSE Cedex (FR)

(72) Inventor: Yannick BURY, Couffouleux (FR)

(21) Appl. No.: 16/083,269

(22) PCT Filed: Mar. 7, 2017
(86) PCT No.: PCT/EP2017/055299

§ 371 Date: Sep. 7, 2018

(30) Foreign Application Priority Data
Mar. 10, 2016 (FR) 1652008

(51) Int. Cl. B64C 9/36; B64C 21/00

(52) U.S. Cl. CPC B64C 9/36; B64C 21/00

(57) ABSTRACT

A device is provided for attenuating the vortex wake created in the zone behind an aircraft, the aircraft having at least one wing and an afterbody having a strong upward asymmetrical reduction of section of the rear fuselage. The device is positioned downstream of the wing of the aircraft symmetrically relative to the longitudinal plane of the aircraft. The device includes vortex-generating aerodynamic appendages capable of being deployed between a folded-down position in which the aerodynamic appendages are folded down substantially in the direction of the fuselage, capable of switching from a folded-down position in which they are folded down substantially in the direction of the fuselage, and a deployed position calculated to generate vortex structures having an intensity and a trajectory which modify the local pressure field in order to interact with the vortex wake to attenuate it and separate the upsweep vortices from the longitudinal plane of the aircraft.

### FIELD OF THE INVENTION

The invention relates to the field of air transport, and more particularly proposes a device for attenuating the vortex wake produced at the rear of transport airplanes having a rear form with rapid reduction of section.

### STATE OF THE ART

The form of the afterbody of military transport or other transport airplanes is conditioned by their operational role of air-dropping of personnel or of equipment from variable flight altitudes. To address this need, these airplanes are equipped with side doors, called “paratrooper” doors, for the air-dropping of paratroopers at a moderate rate. They also have an afterbody having a strong upward asymmetrical reduction of section of the rear fuselage, known as “upsweep”, which makes it possible to incorporate therein a rear door and a ramp. The latter can be opened in flight to ensure the air-dropping at a rapid rate of paratroopers or the air-dropping of equipment, of potentially high tonnage.

The upsweep is responsible for a significant increase in aerodynamic drag. It also generates a three-dimensional and intense vortex flow in the wake close to the airplane which provokes, at the rear of the airplane, the reflux of the flow toward the plane of symmetry of the airplane and upward, with a strong uplift.

The contra-rotating vortex structures thus generated symmetrically relative to the plane of symmetry of the airplane, which are intense and qualified as wake vortices or upsweep vortices, are sources of various problems in air-dropping operations, such as, for example:
air-dropped objects which can come into contact with the tail cone;
deflected initial trajectories of the air-dropped equipment or personnel;
an increased delay in extracting air-dropped equipment from the cargo bay, through the rear door, due to a partial loss of effectiveness;
an increased delay in the opening of both the extraction and decelerating parachutes used to decelerate the air-dropped equipment, these parachutes even having a risk of flaring;
a centered trajectory of the air-dropped paratroopers through the side doors or the rear door, provoking a risk of collision between paratroopers in the near wake, known as the “centerlining” phenomenon;
an initial uplift of the rear-door-air-dropped, low tonnage equipment, undermining the safety of the aircraft.

In a different context of transport airplanes used for example in the fight against forest fires or against offshore pollutions by hydrocarbons (or other pollutants), the upsweep vortices tend to disperse the chemical products air-dropped over the rear part of the airplane. These strongly corrosive products then deposit on the structural elements of the airplane, the rear fuselage, the control surfaces among other things, provoking a premature degradation of the materials.

It is known practice to use, on airplanes dedicated to air-drop missions, devices which make it possible to guide the air flows. A first approach consists in placing lateral deflectors upstream of the side doors. The purpose of these devices, resembling small doors deployed when the air-dropping of the paratroopers is operated through the side doors, is to limit the strong wind gradient undergone by the paratroopers at the moment of their extraction from the flight deck of the aircraft.

In the patent application WO 2013/100767 A1, it is proposed to add, on different zones of the fuselage of an airplane, appendages which can be adjusted between a neutral position of rest and a deployed working position in order to create control surfaces of the fuselage in case of stalling or other disturbances, by influencing the air currents around the aircraft.

However, these deflectors do not attenuate the intensity or the positioning of the vortex cores generated by the rear form of the fuselage of the aircraft in the upsweep zone. Also, the impact of the wake vortices on the air-dropping operations remains unaffected, whether the side door deflectors are deployed or not.

Another known approach consists in placing fixed appendages called upsweep “strakes”, positioned at the rear cone, at the rear end of the upsweep zone. The purpose of these appendages is to reduce the impact of the wake of the airplane on the air-dropping operations. However, it is recognized that the true effectiveness of these fixed devices is low. That results in particular from the fact that these devices are positioned far downstream of the zone in which the upsweep vortices initiate, thus making the control of these vortices all the less effective since the latter have already acquired a maximum intensity before even interacting with the upsweep strakes intended to lessen them. Also, the very design of these strakes, and the positioning thereof relative to the local airflow, cannot impart sufficient energy to the flow to produce a sufficiently notable effect in the reduction of the intensity of the upsweep vortices. Finally, the positioning of these appendages can prove hazardous for the safety of the air-dropped personnel and equipment. Indeed, there is a risk of contact, even of attachment, between the heavy load extraction parachutes and the strakes during the cargo bay output phases. Likewise, the risk of contact between the automatically-opening parachutes of personnel air-dropped through the paratrooper doors and the strakes cannot be precluded. Such a scenario can result in the loss of air-dropped equipment, with attendant risks for people or goods on the ground. The presence of these appendages with relatively sharp design at the rear cone of the fuselage can also represent a risk for the physical integrity of air-dropped personnel in case of impact with these appendages in their jump trajectory, or in case of failure of the automatic parachute opening system, the personnel being able to remain attached to the static line linked to the aircraft and then being subjected to the effect of the upsweep vortices.

Thus, there is no solution for significantly reducing the vortex wake of airplanes having a rear form with rapid reduction of section, which would make it possible to eliminate or reduce the problems resulting from the interaction of the vortex wake with loads or people air-dropped through the side doors or the rear door. The present invention addresses this need.

One object of the present invention is to propose a device, suited to air transport- and air-dropping-dedicated vehicles, having a rear form with rapid reduction of section, which makes it possible to significantly reduce the intensity of the vortex structures that develop in the near wake of these vehicles and to significantly modify the trajectory thereof by separating them for example from the longitudinal plane of symmetry of the vehicle.

Advantageously, the device of the present invention makes it possible to optimize the rate of the air-dropping operations and the accuracy thereof and thus limit the loss of equipment in air-dropping operations, and guarantee a better safety of troops or people on the ground. It also makes it possible to guarantee the safety of air-dropped personnel.

Another object of the present invention is to propose a device suited to air-dropping missions of paratrooper air-dropping type through the side doors and of load and/or personnel air-dropping type through the rear cargo door.

In general terms, the invention is based on the combined principle of a re-energizing of the boundary layer and of a vortex interaction between the vortex structures produced by the air flows around the aircraft, and vortex structures or sheets deliberately generated by virtue of vortex-generating aerodynamic appendages, which can be deployed in air-dropping operations in order to limit the impact thereof on the aerodynamic drag and which are oriented in a predetermined or modular way relative to the air flow.

More generally, the present invention will advantageously be applicable in missions involving air-dropping and/or in-flight recovery of squadrons of drones, or even high-altitude air-dropping of space launch vehicles, by offering a better control of the initial air-dropping conditions and conditions of flow in proximity to the airplane.

The invention will also advantageously be applicable in the field of the air-dropping of chemical products dedicated to forest fire fighting or to the fight against offshore pollutions by hydrocarbons (or other polluting products).

According to one embodiment, a device for attenuating the vortex wake created in the zone behind an aircraft is proposed, the aircraft having at least one wing and an afterbody having a strong upward asymmetrical reduction of section of the rear fuselage. The device is positioned downstream of the wing of the aircraft, on each side of the fuselage of the aircraft symmetrically relative to the longitudinal plane of symmetry of the aircraft. It comprises at least two vortex-generating aerodynamic appendages capable of being deployed between a folded-down position in which the aerodynamic appendages are folded down substantially in the direction of the fuselage, and a deployed position, the deployed position being calculated to generate vortex structures having an intensity and a trajectory which modify the local pressure field in order to interact with the vortex wake to attenuate it and separate the upsweep vortices from the longitudinal plane of symmetry of the aircraft.

In one embodiment, the device comprises hydraulic or electrical or electrohydraulic or electromechanical means making it possible to deploy the aerodynamic appendages according to a given angle, being able to a range up to maximum deployment which then positions the appendage substantially vertically to the local surface of the fuselage.

In one embodiment, each aerodynamic appendage in deployed position is oriented according to a predetermined angle of incidence ‘a’, defined relative to the local flow lines of the flow arriving on the aerodynamic appendage.

In one embodiment, the angle of incidence ‘a’ ranges between −20° and +30°.

In one embodiment, the device comprises hydraulic or electrical or electrohydraulic or electromechanical means making it possible to vary the angle of incidence ‘a’ of the aerodynamic appendages in deployed position.

In one embodiment, the aerodynamic appendages are of substantially delta wing form, having two substantially right-angled edges (b, h) of which one, the base ‘b’, is placed adjacent to the surface of the aircraft and of which the other, the height ‘h’, is substantially at right angles to the surface of the aircraft when the appendage is in fully deployed position.

In one embodiment, the ratio ‘b/h’ between the base and the height of the two edges of the aerodynamic appendage is of the order of two. It can however be set within a wider range, typically of the order of 1 to 3, depending on the layout constraints specific to the aircraft concerned.

In one embodiment, the height ‘h’ of an aerodynamic appendage lies within a range ranging from approximately 50% to 120% of a predefined thickness ‘O’ of the boundary layer, without that constituting a limitation.

In one embodiment, the aerodynamic appendages are produced in a material similar to that of the fuselage of the aircraft.

In one embodiment, the device comprises software means making it possible to manage the deployment of said at least two aerodynamic appendages and the orientation of each of said at least two appendages.

The invention also covers an aircraft having an afterbody having a strong upward asymmetrical reduction of section of the rear fuselage which comprises at least one device for attenuating the vortex wake created in the zone behind the aircraft as claimed.

In one embodiment, the aircraft comprises at least one side door and at least one device positioned in the vicinity and upstream of the side door.

In one embodiment, the device comprises a first aerodynamic appendage positioned at approximately ⅓ of the height of the fuselage of the aircraft and a second aerodynamic appendage positioned at approximately ⅔ of the height of the fuselage of the aircraft. In an advantageous implementation, the appendages are positioned symmetrically on each side of the aircraft, at a distance upstream of the side doors and in the longitudinal direction of the aircraft by approximately 1 to 5 times the height ‘h’ of the aerodynamic appendage.

In an embodiment in which an aircraft having an afterbody having a strong upward asymmetrical reduction of section of the rear fuselage comprises at least one door and/or a rear ramp for air-dropping through the door and/or rear ramp, the device for attenuating the vortex wake created in the zone behind the aircraft as claimed is positioned along the upsweep zone, on each side along the door and/or the rear ramp, on the fixed part of the fuselage, in an azimuthal position slightly upstream of the separating line of the flow.

In one embodiment, the device claimed is composed of a plurality of aerodynamic appendages positioned ramp-fashion in a longitudinal direction of the fuselage.

In one embodiment, the aerodynamic appendages are regularly spaced.

The invention also covers a method for attenuating the vortex wake, created by an aircraft having an afterbody having a strong upward asymmetrical reduction of section of the rear fuselage, the aircraft comprising a device as claimed, the method comprising the steps of:

deploying and orientating said at least two aerodynamic appendages of the device according to an angle of incidence having a predefined initial value;

measuring the pressure in the zone of the aircraft representative of the presence of vortex structures; and

adjusting the angle of incidence of the aerodynamic appendages as a function of the measured pressure.

In one embodiment, the step of adjustment of the angle of incidence consists in ages locking the append according to the incidence for which the measured pressure is maximized.

In one embodiment, the step of measuring the pressure consists in measuring the pressure on the upper surface of said appendages, and the step of adjustment of the angle of incidence comprises the steps of:
varying the angle of incidence of the appendages;
measuring the pressure on the upper surface for a given position of the aerodynamic appendages; and
locking the appendages according to the incidence for which the measured pressure is minimized.

The invention also covers a computer program product, said computer program comprising code instructions making it possible to perform the steps of the method claimed, when said program is run on a computer.

The invention also covers an information storage means, removable or not, partially or totally readable by a computer or a microprocessor comprising code instructions of a computer program for the execution of each of the steps of the method claimed.

### DESCRIPTION OF THE FIGURES

Different aspects and advantages of the invention will become apparent in support of the description of a preferred, but non-limiting, mode of implementation of the invention, with reference to the figures below:

FIG. 1 schematically shows a transport airplane on which a device of the invention has been installed;

FIG. 2a shows an aerodynamic appendage according to the invention in retracted position;

FIG. 2b illustrates different forms of aerodynamic appendages according to the invention;

FIG. 3 shows an aerodynamic appendage according to the invention in deployed position;

FIGS. 4a and 4b show two embodiments of the device of the invention according to a first variant implementation upstream of a side door;

FIG. 5 shows an embodiment of the device of the invention according to a variant implementation for a rear air-dropping door;

FIG. 6 shows a sequence of steps making it possible to adjust the incidence of the appendages of the device of the invention.

### DETAILED DESCRIPTION OF THE INVENTION

In general terms, the principle of the invention consists in controlling the generation of vortex sheets by the placement of series of aerodynamic appendages called vortex generators (VGs) at chosen locations on the fuselage of the aircraft, in zones of the fuselage downstream of the wing, symmetrically relative to the longitudinal plane of symmetry of the airplane. The positioning of the aerodynamic appendages is defined so as to ensure both an optimal efficiency for the reduction of the intensity of the upsweep vortices, and the modification of the trajectory thereof in the near wake of the airplane, by separating them, for example, from the longitudinal plane of symmetry of the airplane, while guaranteeing a deployment of these appendages outside of the potential zones of interaction with the air-dropped personnel or equipment.

Preferentially, the positioning of the appendages is situated in the upstream zone where the upsweep vortices originate. By producing a series of vortex structures upstream of the zone where the air flow naturally separates from the rear fuselage of the airplane and produces upsweep vortices, the air flow is initially re energized, then delaying its separation at the upsweep zone, then delaying its consecutive winding into upsweep vortices. The vortex structures or sheets deliberately produced by the series of aerodynamic appendages interact with the natural upsweep vortices. This interaction produces an intense shearing, responsible for the production of small-scale turbulences, which makes it possible to more rapidly dissipate the upsweep vortices and the vortex structures produced by the appendages and makes it possible to augment the diffusion of the vortices thereof through an increase of their radius, a strong reduction of their intensity and of their speed of rotation.

Moreover, the generation by the aerodynamic appendages of the different vortex structures induces a local modification of the pressure field which affects the trajectory of the upsweep vortices. These vortices are then offset substantially from the plane of symmetry of the airplane, and therefore from the zone of operability for air-dropping missions, thus making the operations safer.

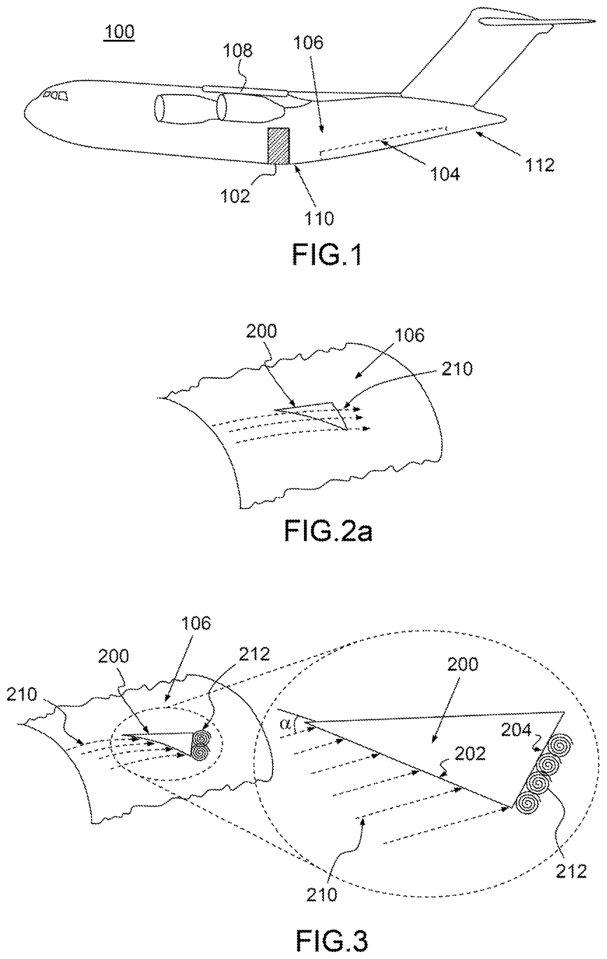

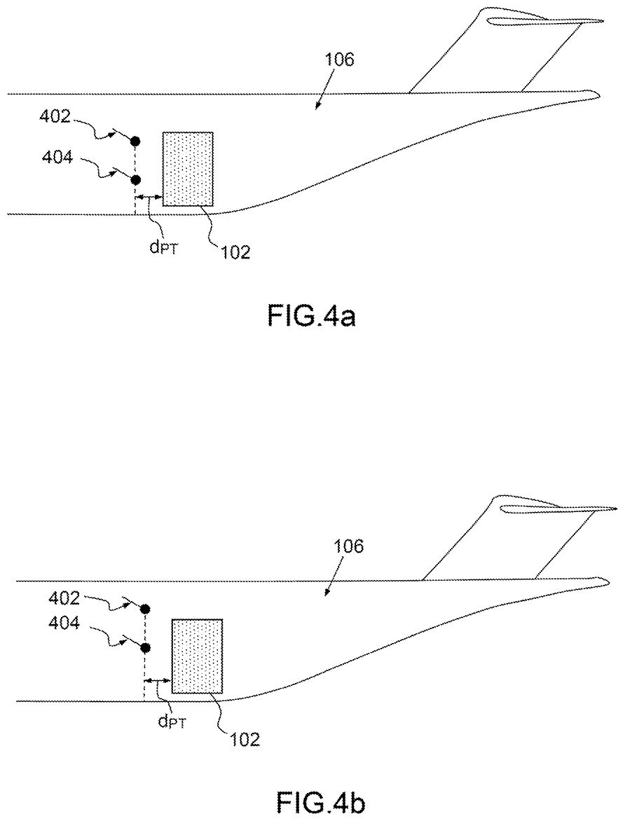

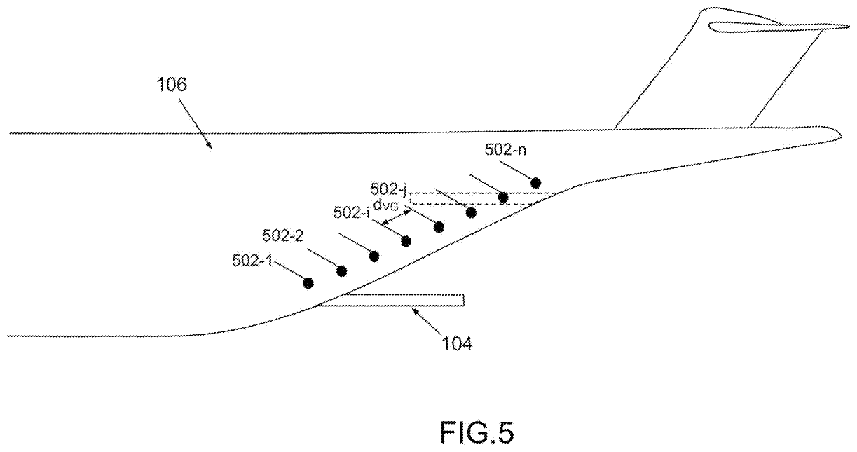

FIG. 1 schematically illustrates a transport airplane (100) on which a device according to the invention can be installed. Such a type of aircraft has an afterbody (106) having a strong upward asymmetrical reduction of section of the fuselage (110). This zone with strong upward asymmetrical reduction of section of the fuselage is called upsweep zone. As detailed later with reference to FIGS. 4 and 5, aerodynamic appendages can be arranged in zones of the fuselage downstream of the wing (108), at the side doors (102) and/or the rear door (104) symmetrically relative to the longitudinal plane of symmetry of the aircraft. The person skilled in the art understands that, for reasons of simplification, FIG. 1 illustrates a side view of the airplane, but the latter can have another symmetrical side door where aerodynamic appendages can also be installed. Likewise, the rear appendages are positioned symmetrically on either side of the fuselage. Preferentially without constituting a limitation, the aerodynamic appendages are produced in a material similar to that of which the fuselage of the aircraft is composed or in any material compatible with the rules of airplane design art, capable of withstanding the mechanical stresses induced by the airflows, by guaranteeing the rigidity of the device.

Advantageously, the aerodynamic appendages can be deployed on demand. In a first retracted position, the appendages are folded down substantially in the direction of the fuselage. They can be brought into a second deployed positon, where they are deployed substantially vertically relative to the surface of the fuselage. In an initial flight phase, the appendages are preferably in folded-down position, then deployed for the duration of the air-dropping operations. The appendages can be retracted once again after the end of the air-drop, thus making it possible to control the fuel consumption or the noise emitted throughout the duration of the flight.

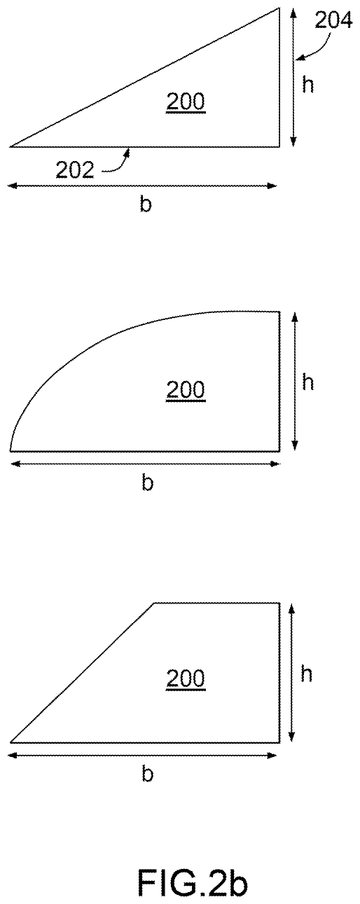

FIG. 2a illustrates an aerodynamic appendage (200) in retracted mode positioned on the fuselage (106) of an airplane. In this mode, the appendages are embedded in the surface of the fuselage, not forming an obstacle to the existing flow, as illustrated by the local air flow flux lines (210) in FIG. 2a. In a preferential embodiment, the aerodynamic appendages (200) are of delta wing form, having two substantially right-angled edges (b, h) of which one, the base ‘b’, is placed adjacent to the surface of the aircraft and of which the other, the height ‘h’, is substantially at right angles to the surface of the aircraft when the appendage is in fully deployed position. This edge of height ‘h’ can have a smaller angle than that at right angles to the surface of the aircraft when the appendage is not fully deployed.

The person skilled in the art will be able to adapt, without adversely affecting the efficiency thereof, the form and the dimensions of these appendages as a function of the existing constraints for their incorporation on each type of airplane. As variants, a few forms of aerodynamic appendages suited to the vortex attenuation device of the invention are illustrated in FIG. 2b.

FIG. 3 shows an aerodynamic appendage ‘VG’ (200) in deployed position on the fuselage (106) of an airplane, according to one embodiment. The deployment of an aerodynamic appendage forms an obstacle to the local flux lines of the airflow (210) and, behind a deployed aerodynamic appendage, vortex structures (212) are created, the intensity and the trajectory of which are controlled by the form, the positioning on the fuselage, the degree of deployment and the alignment in incidence of the aerodynamic appendages.

By taking the delta wing form shown in FIG. 2a, the aerodynamic appendage (200) preferentially has a ratio ‘b/h’ of the order of ‘2’ between its base ‘b’ (202) and its height ‘h’ (204).

Advantageously, the thickness of the aerodynamic appendages VGs is not critical for the efficiency of the device of the invention, and it can be set according to the dimensioning rules associated with the mechanical strength of these appendages subject to wind, in conditions of flight relating to the deployment thereof.

The height ‘h’ of an aerodynamic appendage is preferably determined relative to the thickness ‘δ’ of the local boundary layer at the zone of installation, and set at a few tens of percentage of this thickness. It is well known to the person skilled in the art that the boundary layer is defined as the zone of interface between a body and a surrounding fluid in a relative movement between the two, and as being the zone where the rate of flow is slowed down by the wall. It begins at the surface contact where the rate of flow is practically nil and extends through a distance where the rate of flow is substantially equal to that of the free flow, a distance giving the thickness ‘δ’ of the boundary layer.

According to variant implementations, the height ‘h’ of an aerodynamic appendage VG can range from approximately 50% to 120% of the thickness ‘δ’ of the boundary layer.

Although not illustrated, the deployment of an appendage is done by common place means making it possible to ensure the robustness of the mechanism, by using, for example, hydraulic or electrohydraulic cylinders, of a type similar to those implemented for example for the deployment of lateral deflectors embedded on airplanes such as an Airbus A400M or a Boeing C17, but having a dimensioning and a power suited to the alar surface of each of the appendages, which is much less than that of the lateral deflectors.

Preferentially, for maintenance reasons, but also for minimization of the cables and pipes connecting to the hydraulic and electrical utilities (cables, etc.) for supplying the devices, the aerodynamic appendages VGs are installed in zones of the fuselage downstream of the wing where the hydraulic and/or electrical utilities necessary to the deployment of the appendages are easily accessible, the whole also allowing for a weight saving.

The deployed appendages can be raised to an opening of approximately 90° relative to the local surface of the fuselage.

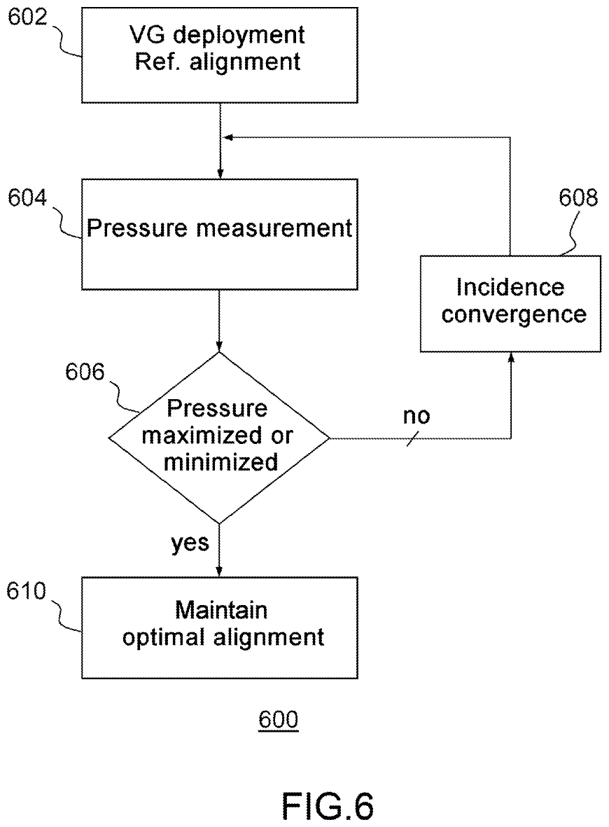

Advantageously, the appendages can be oriented. The incidence ‘a’ relative to the local flow lines of the airflow, initially defined at a nominal value associated with a given mission, can be adjustable for each appendage. The angle of incidence can be adjusted via a hydraulic, electrical, electrohydraulic or even electromechanical rotation device (not illustrated) about the axis of the cylinder used for the deployment of the appendage, and controlled on demand by the onboard personnel, from a control interface, or automatically by a logic controller operating in closed loop mode as represented subsequently with reference to FIG. 6.

The exact positioning and the alignment in incidence of each of the appendages can be refined as a function of the local flux lines of the flow, as a function of the type of airplane concerned in mission configuration. It should be noted that the local flux lines are determined previously during the development of the airplane, through digital simulations, wind tunnel tests or in-flight tests.

Advantageously, the range of variation of the local incidence can lie between ‘α=−20° ’ and ‘α=+30° ’ according to the zone of installation and the mission targeted.

FIGS. 4a and 4b show two embodiments of the device of the invention that are particularly suited to paratrooper air-dropping through the side door. In this configuration, designated in the present description as “TwinVG” configuration, the device is composed of a pair of aerodynamic appendages (402, 404) positioned on the fuselage (106), upstream of the side door (102), for each side door of the airplane. The coupling created between the two aerodynamic appendages, through their geometry and their positioning, produces controlled vortex sheets which interact with the upsweep vortexes to attenuate the intensity thereof and modify the trajectory thereof.

Preferentially as illustrated in FIG. 4a, the two vortex-generating appendages (VGs) are positioned at approximately ⅓ of the height of the fuselage for the first appendage (402) and at approximately ⅔ of the height of the fuselage for the second appendage (404), on each side of the fuselage symmetrically. However, as illustrated in FIG. 4b, the vertical positioning can be slightly adapted according to the installation constraints depending on the type of airplane, without penalizing the efficiency of the device.

In one embodiment, the vertical spacing between the two aerodynamic appendages of one pair is calculated to be of the order of two times the height ‘h’ of the appendage VG. However, variants with a reasonable tolerance margin are applicable to this value.

The aerodynamic appendages are, in a preferential embodiment, installed at a distance ‘d_{PT}’ from the side door, a distance defined as being of the order of 1 to 5 times the height ‘h’ of the appendages.

FIG. 5 illustrates an embodiment of the device of the invention that is particularly suited for air-dropping through the door and/or rear ramp (104). In this configuration, designated in the present description as “VGramp” configuration, the device is composed of a plurality of aerodynamically appendages (502-1 to 502-n) positioned ramp-fashion along a longitudinal direction of the fuselage (106) and evenly spaced apart from one another. In a preferential embodiment, the distance ‘d_{VG}’ between two aerodynamic appendages VGs is chosen to be equal to approximately two times the height ‘h’ of the appendage. However, variants with a reasonable tolerance margin are applicable to this value.

The plurality of aerodynamic appendages VGs is situated all along the upsweep zone, symmetrically on either side of the fuselage, alongside the door and/or rear ramp, on the fixed part of the fuselage, in an azimuthal position on the fuselage, slightly upstream of the flow separating line. The separating line and the local flux lines in the zone of installation of the ramps of aerodynamic appendages have been previously determined during the development of the airplane, through digital simulations, wind tunnel tests or in-flight tests.

Advantageously, with each appendage being deployable on demand, the alignment in incidence ‘a’ of each appendage can be adapted relative to the local flux lines. Preferentially, the adjustable of the angle of incidence is situated between ‘α=−20° ’ and ‘α=+30° ’, the value depending on the zone of installation and on the air-dropping mission targeted.

Advantageously, the adaptive alignment in incidence of each of the appendages can be managed by software means in the form of an algorithm taking into account real-time pressure measurements, on points distributed in the rear cone zone of the fuselage (112), and distributed symmetrically on either side of the plane of symmetry of the airplane.

The method (600) of alignment of the incidence is described in FIG. 6. The method begins (602) with the activation of the deployment of an aerodynamic appendage VG and its alignment in incidence according to an initial reference value (602). The initial incidence value is a value predefined before the air-dropping operations and dependent on the air-dropping mission and on the type of aircraft.

Then, the method makes it possible (604) to recover pressure values measured in real time in the rear cone zone of the fuselage (112). The person skilled in the art understands that the pressure measurements can be performed by known components of pressure sensor type. It should be noted that the method is described to allow the alignment in incidence of a single aerodynamic appendage but it is applicable for all or some of the appendages implemented. Moreover, the alignment can have one and the same value for all of the appendages or be set at different values.

In a next step, the method seeks to maximize the pressure measured in the rear cone zone of the fuselage (112), at the end of the upsweep zone, by varying the alignment in incidence of the different appendages (606). The method enters into a process of convergence (608) which makes it possible to vary the incidence of the appendage VG to reach the maximized pressure value. When a local maximum of pressure is obtained by varying the alignment and incidence of the different VGs, the alignment in incidence is considered optimal and the appendage VG is kept on this alignment (610).

In one embodiment, the step of convergence (608) to the optimal alignment of each of the appendages consists in varying the incidence about the reference alignment value, within a range of variation predefined during an initial calibration obtained by simulations, in a wind tunnel or during certification tests.

In an alternative mode, the step of measurement of the pressure (606) consists in measuring the pressure on the upper surface of each of the appendages VGs and the step of convergence (608) consists in varying the incidence to minimize the upper surface pressure of the appendage, and block the appendage in the orientation according to the incidence giving the minimized pressure value.

Advantageously, the capacity to robustly adapt the alignment in incidence of the different aerodynamic appendages guarantees the device of the invention a maximum efficiency despite possible variations of the air-dropping conditions, such as the speed of the airplane, the wind imbalance relative to the airplane, the greater or lesser opening of the ramp and of the rear door, for example, or of the mission conditions, which would require air-dropping speeds given as a function of the aircraft, of the flight altitude, of the type of air-dropped equipment (tonnage, air-dropping rate, etc.), but also of the chance conditions associated with the weather, the theatre of operation not necessarily secured (air drop not necessarily possible in the axis of the prevailing wind), etc.

The person skilled in the art will appreciate that variations can be made to the implementation described preferentially, while maintaining the principles of the invention.

1. A device for attenuating the vortex wake created in the zone behind an aircraft, the aircraft having at least one wing and an afterbody having a strong upward asymmetrical reduction of section of the rear fuselage, the device being positioned downstream of the wing of the aircraft symmetrically relative to the longitudinal plane of the aircraft, the comprising:
at least two vortex-generating aerodynamic appendages capable of being deployed between a folded-down position in which the aerodynamic appendages are folded down substantially in the direction of the fuselage, and a deployed position, the deployed position being calculated to generate vortex structures having an intensity and a trajectory which modify the local pressure field in order to interact with the vortex wake to attenuate it and separate the upsweep vortices from the longitudinal plane of symmetry of the aircraft.

2. The device as claimed in claim 1, wherein each aerodynamic appendage in deployed position is oriented according to a predetermined angle of incidence ‘α’, defined relative to the local flow lines of the flow arriving on the aerodynamic appendage.

3. The device as claimed in claim 2, wherein the angle of incidence ‘α’ ranges between −20° and +30°.

4. The device as claimed in claim 2, comprising hydraulic or electrical or electrohydraulic or electromechanical means making it possible to vary the angle of incidence ‘a’ of the aerodynamic appendages in deployed position.

5. The device as claimed in claim 1, comprising hydraulic or electrical or electrohydraulic or electromechanical means making it possible to switch the aerodynamic appendages from one position to another position.

6. The device as claimed in claim 1, wherein the aerodynamic appendages are of substantially delta wing form, having two substantially right-angled edges (b, h) of which one constituting the base ‘b’ is placed adjacent to the surface of the aircraft and of which the other constituting the height ‘h’ is at right angles to the surface of the aircraft when the appendage is in fully deployed position.

7. The device as claimed in claim 6, wherein the ratio ‘b/h’ between the base and the height of the two edges of the aerodynamic appendage is of the order of two.

8. The device as claimed in claim 6 or 7, wherein the height ‘h’ of an aerodynamic appendage lies within a range from approximately 50% to 120% of a predefined thickness ‘6’ of the boundary layer.

9. The device as claimed in claim 1, wherein the aerodynamic appendages are produced in a material similar to that of the fuselage of the aircraft.

10. The device as claimed in claim 1, also comprising means for controlling the deployment of said at least two aerodynamic appendages and the orientation of each of said at least two appendages.

11. An aircraft having an afterbody having a strong upward asymmetrical reduction of section of the rear fuselage comprising at least one device as claimed in claim 1.

12. The aircraft as claimed in claim 11, comprising at least one side door and at least one device positioned in the vicinity and upstream of the side door.

13. The aircraft as claimed in claim 11, wherein said at least one device comprises a first aerodynamic appendage positioned at approximately ⅓ of the height of the fuselage and a second aerodynamic appendage positioned at approximately ⅔ of the height of the fuselage.

14. The aircraft having an afterbody having a strong upward asymmetrical reduction of section of the rear fuselage and comprising at least one door and/or rear ramp for air-dropping by door and/or rear ramp, the aircraft comprising at least one device as claimed in claim 1, said at least one device being positioned on the rear fuselage along the afterbody, on each side of the aircraft along the door and/or the rear ramp, on the fixed part of the fuselage, in an azimuthal position slightly upstream of the separating line of the flow.

15. The aircraft as claimed in claim 14, wherein said at least one device is composed of a plurality of aerodynamic appendages substantially aligned in a longitudinal direction of the fuselage.

16. The aircraft as claimed in claim 15, wherein the aerodynamic appendages are regularly spaced.

17. A method for attenuating the vortex wake created by an aircraft having an afterbody having a strong upward asymmetrical reduction of section of the rear fuselage, the aircraft comprising a vortex wake attenuation device as claimed in claim 1, the method comprising the steps of:
deploying and orienting said at least two aerodynamic appendages of the device according to an angle of incidence having a predefined initial value;
measuring the pressure in a zone of the aircraft representative of the presence of vortex structures; and
adjusting the angle of incidence of the aerodynamic appendages as a function of the measured pressure.

18. The method as claimed in claim 17, wherein the step of adjustment of the angle of incidence consists in locking the appendages according to the incidence for which the measured pressure is maximized.

19. The method as claimed in claim 17, wherein the step of measuring the pressure consists in measuring the pressure on the upper surface of said appendages, and the step of adjustment of the angle of incidence comprises the steps of:
varying the angle of incidence of the appendages;
measuring the pressure on the upper surface for a given position of the aerodynamic appendages; and
locking the appendages according to the incidence for which the measured pressure is minimized.

20. A computer program product, said computer program comprising code instructions making it possible to perform the steps of the method as claimed in claim 17, when said program is run on a computer.

21. An information storage means, removable or not, partially or totally readable by a computer or a microprocessor comprising code instructions of a computer program for the execution of each of the steps of the method as claimed in claim 17.
